(19) United States
(12) Patent Application Publication
(10) Pub. No.: US 2009/0175187 A1
(43) Pub. Date: Jul. 9, 2009

(54) Method and Arrangement for Triggering Power Headroom Report Transmissions in a Telecommunications System

(76) Inventors: Kristina Jersenius, Linkoping (SE); Eva Englund, Linkpoing (SE)

Correspondence Address: ERICSSON INC., 6300 LEGACY DRIVE, M/S EVR 1-C-11, PLANO, TX, 75024, US

(21) Appl. No.: 12/346,304

(22) Filed: Dec. 30, 2008

Related U.S. Application Data
(60) Provisional application No. 61/019,390, filed on Jan. 7, 2008.

(51) Int. Cl. H04L 12/26

(52) U.S. Cl. 370/252

(57) ABSTRACT

The present invention relates to a method and arrangement for triggering transmission of a power headroom report to be used by a base station for estimating UE transmit power also for transmissions for which a power headroom report is not included. The user equipment, UE, is to this end configured with a set of triggering conditions for power head room report transmission.

### CROSS-REFERENCE TO RELATED APPLICATIONS

This application claims the benefit of U.S. Provisional Application No. 61/019,390, filed Jan. 7, 2008, the disclosure of which is incorporated herein by reference.

### TECHNICAL FIELD

The present invention relates to a method and arrangement in a telecommunications system, in particular it relates to a method and arrangement for triggering power headroom report transmissions in a telecommunications system.

### BACKGROUND

Radio access technologies for cellular mobile networks are continuously being evolved to meet the future demands for higher data rates, improved coverage and capacity. Examples of recent evolutions of the WCDMA access technology are HSPA (High-Speed Packet Access). Currently further evolutions of the 3G systems, 3G Long Term Evolution (LTE), including new access technologies and new architectures are being developed within the 3rd Generation Partnership Project (3GPP) standardization body.

The LTE concept supports fast scheduling and link adaptation in frequency and time domain both for the uplink (UL) and the downlink (DL). This means that the resource assignment in time and frequency can be adjusted to the users' momentary traffic demand and channel variations. In the LTE uplink it is possible to schedule several users simultaneously (in the same subframe) by assigning different frequency segments to different users. To maintain the single carrier structure each user can only receive contiguous assignment in frequency as illustrated in FIG. 1.

In general, excessive power usage should be avoided to save UE battery life and to avoid both intra-cell and inter-cell interference. The LTE specifications supports a base station, i.e. eNodeB, control mechanism for the UE transmit power.

The power control mechanism is basically set in 3GPP but some details still remain. The setting of the user equipment (UE) Transmit power P_{PUSCH} for the physical uplink shared channel (PUSCH) transmission in subframe i is defined by:

P_{PUSCH}(i)=min{P_{MAX},10 log₁₀(M_{PUSCH}(i))+P_{O}_{_{—}}_{PUSCH}+α·PL+Δ_{MSC}(MCS(i))+f(i)} [dBm] (1)

where,
P_{MAX} is the maximum allowed power that depends on the UE power class
M_{PUSCH}(i) is the bandwidth of the PUSCH transmission expressed in number of resource blocks taken from the resource allocation valid for uplink subframe i from scheduling grant received on subframe i−K_{PUSCH}.
P_{O}_{_{—}}_{PUSCH} is a parameter with 1 dB resolution composed of the sum of a 8-bit cell specific nominal component P_{O}_{_{—}}_{NOMINAL}_{_{—}}_{PUSCH} signalled via broadcast control channel (BCCH) on the physical downlink shared channel (PDSCH) in the range of [−126,24] dBm and a 4-bit UE specific component P_{O}_{_{—}}_{UE}_{_{—}}_{PUSCH} signalled via radio resource control (RRC) in the range of [−8, 7] dB.
αε{0, 0.4, 0.5, 0.6, 0.7, 0.8, 0.9, 1} is a 3-bit cell specific parameter signalled via BCCH on the PDSCH
PL is the downlink pathloss estimate calculated in the UE from a reference symbol received power (RSRP) measurement and signalled reference symbol (RS) transmit power
Δ_{MSC}(MCS(i)) table values are cell specific and given by RRC (Δ_{MSC}(MCS) table entries can be set to zero) and MCS(i) is the PUSCH MCS valid for subframe i taken from a PDCCH with scheduling grant format received on subframe i−K_{PUSCH}.
Δ_{PUSCH} is a UE specific correction value, also referred to as a transmit power control (TPC) command and is included in physical downlink control channel (PDCCH) with scheduling grant format or jointly coded with other TPC commands in PDCCH with TPC-PUSCH format. The current PUSCH power control adjustment state is given by f(i) which is defined by:
   f(i)=f(i−1)+Δ_{PUSCH} is (i−K_{PUSCH}) if f(*) represents accumulation
      where f(0)=0 and K_{PUSCH}=[4]
      The UE attempts to decode a PDCCH of scheduling grant format and a PDCCH of TPC-PUSCH format in every subframe except when in discontinuous reception (DRX) mode
      Δ_{PUSCH}=0 dB for a subframe where no TPC command is decoded or where DRX occurs.
      The Δ_{PUSCH} dB accumulated values signalled on PDCCH with scheduling grant format are either [−1,0,1,3] or [−3,−1,1,3] as semi-statically configured by higher layers.
      The Δ_{PUSCH} dB accumulated values signalled on PDCCH with TPC-PUSCH format are one of [−1,1], [−1,0,1,3] or [−3,−1,1,3] as semi-statically configured by higher layers.
         f(i)=Δ_{PUSCH}(i−K_{PUSCH}) if f(*) represents current absolute value
         where Δ_{PUSCH}(i−K_{PUSCH}) was signalled on PDCCH with scheduling grant format on subframe i−K_{PUSCH}
         where K_{PUSCH}=[4]
         The Δ_{PUSCH} dB absolute values signalled on PDCCH with scheduling grant format are [−4,−1,1,4].
         f(*) type (accumulation or current absolute) is a UE specific parameter that is given by RRC.

The power control mechanism aims to keep the received Signal-to-Noise Ratio (SNR) (or Signal-to-Noise and Interference Ratio (SINR) (when interference is accounted for) below a targeted value SNR_{target}. The UE power usage depends also on the scheduled bandwidth as illustrated in FIG. 2. The UE power needs to be shared over the allocated bandwidth (BW). A UE in a poor radio condition may not reach the targeted SNR even with a small bandwidth allocation. For a UE in a good radio condition the UE power may be sufficient to fill the entire available bandwidth (BWₘₐₓ) and still reach the target SNR. For a UE in intermediate radio condition the power may be sufficient up-to a certain bandwidth (BW*). For BW allocations that are greater than BW* the UE will transmit with the maximum available power and the received SNR will depend on the momentary link pathgain.

The link adaptation function estimates the transmission parameters (modulation and coding) based on an estimated SNR (or SINR if interference is estimated). As is seen in FIG. 2 the LTE base station, i.e. eNodeB, needs to estimate the radio propagation condition, i.e. the pathgain to estimate the received SNR for a certain BW allocation. One estimate could be to use the DL pathgain obtained from hand-over (HO) reports, which however in the best case will reflect only the long-term average UL pathgain and does not enable the UE to follow the instantaneous channel variations.

To do an efficient link adaptation and scheduling the eNodeB needs knowledge of the uplink gain of the user. To estimate the uplink gain the eNodeB should know both the received power from the UE and the transmit power of the UE. The eNodeB knows the received power from measurement on the uplink transmission, but the UE transmit power is known only if the UE reports the transmit power to the eNodeB.

In 3GPP, it has been decided that the UE will measure power headroom and most likely also report the power headroom. The content and the triggering of the power headroom report are not decided. The content may e.g. be the difference between UE maximum power and UE transmit power, either a total value or a value per resource block, or the UE transmit power, either a total value or a value per resource block. For the power headroom report to be of any value it should be possible to tie the transmission to a certain transmission and scheduling, preferably the power headroom report is included in the same sub frame as it is valid for.

To include the power headroom report in every uplink transmission would however cause a lot of overhead. If the power headroom report is not included in every retransmission the eNodeB must estimate the transmit power for the transmissions in which power headroom reports are not included to be able to update its uplink gain estimate.

In formula (1) above it is seen that the only unknown component, of the UE transmit power, which is unknown to the eNodeB is the downlink path loss. A possible solution attempt to the problem of providing the eNodeB with as much power headroom reporting that is needed to estimate the UE transmit power is to configure the UE to transmit a power headroom report when the downlink path loss changes. A reported power headroom that gives a total UE transmit power which is below the UE maximum power enables an estimation of the downlink path loss and hence an estimation of the UE transmit power. The DL pathloss is based on a filtered long-term average and varies moderately from subframe to subframe. This means that the eNodeB may use the DL pathloss estimate obtained to estimate the UE transmit power even for all UL transmissions until a new report is obtained. This in turn provides that for each UL transmission the received power in relation to transmit power may be used to obtain an estimate of the UL instantaneous pathloss.

However, if the reported power headroom gives a total UE transmit power which is equal to the UE maximum power it is not possible to estimate the downlink path loss and the UE transmit power for the transmissions to which a power headroom report is not tied. This makes it difficult to continuously update the UL pathloss estimate and update the SNR versus BW curve that is illustrated in FIG. 2.

A second possible solution is to have the eNodeB use the downlink path loss estimates that are available from handover measurement reports to do the UE transmit power estimation. These handover measurements however will typically only be transmitted periodically when the downlink path gain is below a certain value and downlink path gain values above these values will therefore not be available to the eNodeB.

### SUMMARY

It is an object of the present invention to provide a solution for triggering power headroom reports that enables estimating UE transmit power in a communications system that to a certain extent alleviates one or some of the problems indicated above.

It is also an object of the present invention to provide a means for triggering transmitting a power headroom report only when needed, the report contents being valid for estimating UE transmit power for transmissions lacking such data until a new power headroom report is triggered.

A first aspect of the present invention relates to a method in a user equipment of a wireless communication system for triggering transmitting a power headroom report to a base station, such as an eNodeB, for use in estimating UE transmit power.

A first method step of the first aspect of the invention involves determining if at least one preconfigured condition a), b) or c) for triggering transmitting a power headroom report is true. And if at least one of the conditions is found true, in a second method step, generating a report comprising a UE transmit power indicator. A third method step involves transmitting the report with the indicator to the base station for use therein to estimate the UE transmit power.

According to one embodiment of this aspect of the invention, the indicator comprises a value corresponding to a difference between the UE maximum power and the UE transmit power, either absolute or per resource block. Alternatively the indicator comprises a value corresponding to the UE transmit power, either absolute or per resource block.

In another embodiment of this aspect of the invention, the triggering conditions comprise:

a) at least a certain deviation from a value of a previously reported power headroom;
b) at least a certain change in DL pathloss estimate used for power setting;
c) at least a certain elapsed time since a previously reported power headroom.

In a further embodiment of this aspect of the invention, condition a) is true if the current UE transmit power is less than the maximum transmit power and the value of the latest transmitted report corresponds to a UE transmit power being equal to the maximum power; condition b) is true if the downlink path loss change is larger than a certain threshold and the value of the latest transmitted report corresponds to a UE transmit power being less than the maximum power, and condition c) is true if the time since the latest power headroom report transmission is larger than a certain threshold.

In still a further embodiment of this aspect of the invention, the threshold values of conditions b) and c) are configured in the UE via higher layer signaling, such as RRC signaling.

A second aspect of the present invention relates to a method in a base station of a wireless communication system for estimating UE transmit power for transmissions based on a power headroom report received from the UE.

A first method step of the second aspect of the invention involves determining if a transmit power indicator of the report comprises a value corresponding to a UE transmit power that is less than the maximum power, and in case the value indicates that the UE transmit power is less than the maximum power calculating, in a second method step, an estimate of a downlink path loss using that value. A third method step of the second aspect of the invention involves estimating the UE transmit power based on the DL pathloss estimate for data transmissions until receiving a new power headroom report from the UE.

Alternatively, if the indicator value is found corresponding to a UE transmit power that is equal to the maximum power, the base station instead assumes that the UE transmits data at maximum power until receiving a new power headroom report.

A third aspect of the present invention relates to a UE or mobile terminal of a wireless communication system capable of triggering power headroom report transmissions, wherein the terminal comprises means arranged to perform the method according to the first aspect of the invention.

A fourth aspect of the present invention relates to a base station, such as an eNodeB, of a wireless communication system capable of estimating UE transmit power based on power headroom reports from a UE, wherein the base station comprises means arranged to perform the method according to the second aspect of the invention.

The present invention according to the aspects and embodiments thereof herein described provides the advantage of enabling the eNodeB to estimate UE transmit power and hence the uplink path gain without the UE having to include power headroom report in every data transmission.

The features described above in relation to the method according to the invention may, where applicable, also be implemented in an arrangement according to the invention with the same advantages as described in relation to the method.

It goes without saying that the above aspects of the invention may be combined in the same embodiment.

### BRIEF DESCRIPTION OF DRAWINGS

FIG. 1 schematically illustrates resource allocation to different users in an SC-FDMA system;

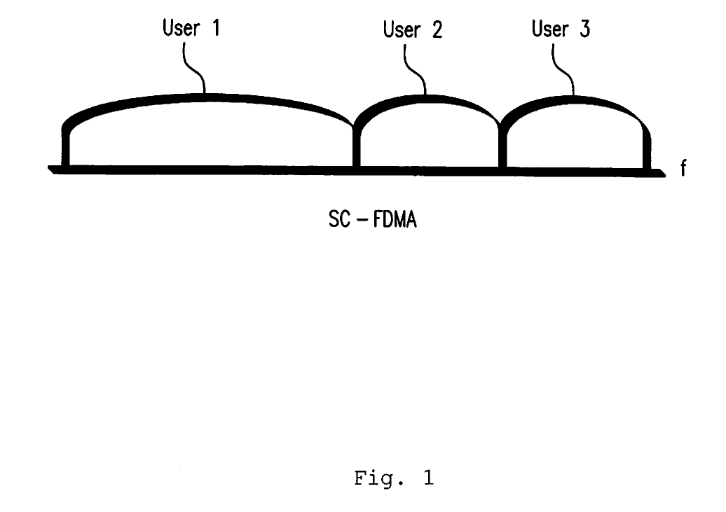

FIG. 2 schematically illustrates how UE power usage and eNodeB received SNR varies dependent on the allocated bandwidth (BW);

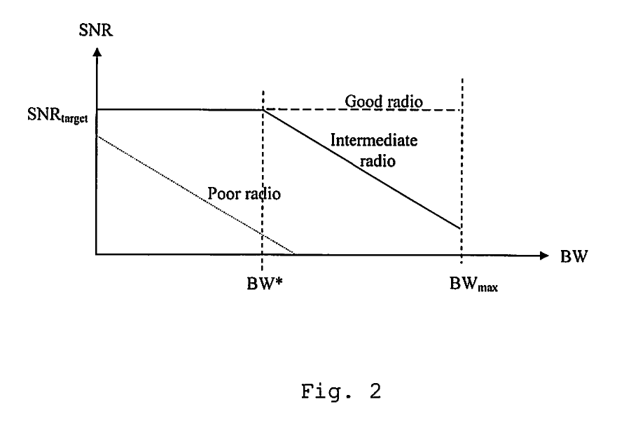

FIG. 3 is a flowchart illustrating steps performed in a UE for triggering a power headroom report to be transmitted to a base station, such as an eNodeB;

FIG. 4 is a flowchart illustrating steps performed in a base station for estimating UE transmit power based on a power headroom report received from the UE; and

FIG. 5 is a general view of a cellular radio system.

### DETAILED DESCRIPTION

In the following, various embodiments of the invention will be described.

Briefly described, the present invention involves a method and arrangement for triggering transmitting a power headroom report to be used by a base station for estimating UE transmit power for subsequent transmissions lacking such data until a new power headroom report transmission is triggered.

A method of the invention according to one embodiment thereof is described in the following:

The UE is configured with a set of triggering conditions for power head room report transmission that enables the eNodeB to estimate the transmit power for the transmissions for which a power headroom report is not included. The triggering of the power headroom reporting should depend on at least one of:

previously reported power headroom,

Change in downlink, DL, path loss estimate used for power setting,

Time since previously reported power headroom,

or combinations of these three.

The UE keeps track of the transmit power that its latest transmitted power headroom report corresponds to, the downlink path loss estimate which was used in the calculation of that transmit power and at what time its previous power headroom report was transmitted. The power headroom report consists of either the difference between the UE maximum power and the UE transmit power, either absolute or per resource block, or UE transmit power, either absolute or per resource block.

The UE will transmit a power headroom report if at least one of the following conditions is true:
a) the UE's latest transmitted power headroom report contains a value corresponding to a total transmit power equal to the maximum power and its current transmit power is less than maximum power,
b) the UE's latest transmitted power headroom report contains a value corresponding to a total transmit power which is less than the maximum power and its downlink path loss change is larger than a certain threshold (configured via higher layer signaling, e.g. RRC),
c) the elapsed time since the previous power headroom report transmission is larger than a certain threshold (configured via higher layer signaling, e.g. RRC).

To avoid some error cases the UE could alternatively relate to the latest acknowledged power headroom report.
a) the UE's latest transmitted and acknowledged power headroom report contains a value corresponding to a total transmit power equal to the maximum power and its current transmit power is less than maximum power,
b) the UE's latest transmitted and acknowledged power headroom report contains a value corresponding to a total transmit power which is less than the maximum power and its downlink path loss change is larger than a certain threshold (configured via higher layer signaling, e.g. RRC),
c) the elapsed time since the previous power headroom report transmission is larger than a certain threshold (configured via higher layer signaling, e.g. RRC).

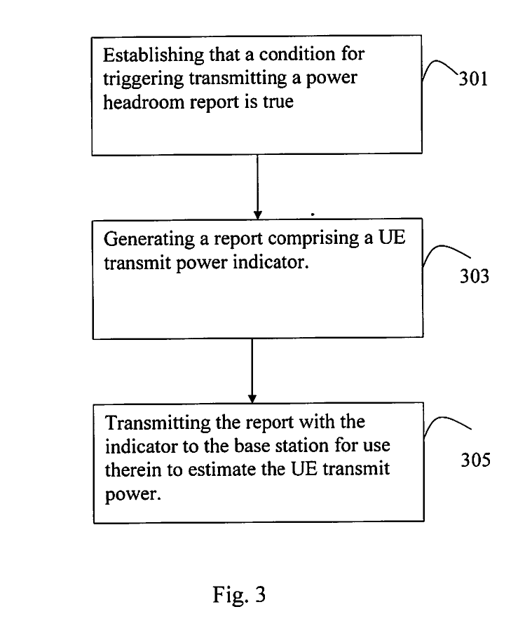

FIG. 3 in a flowchart illustrates steps performed in a UE according to one embodiment of a method for triggering a power headroom report to be transmitted to a base station, such as an eNodeB. The steps involve initially establishing 301 that at least one preconfigured condition a), b) or c), for example one or some of the conditions a), b) or c) described above, for triggering transmitting a power headroom report is true. A power headroom report is then generated 303 comprising a UE transmit power indicator. The report with the indicator is thereafter transmitted 305 to the base station for use therein in estimating the UE transmit power.

Triggering conditions a) and b) provide the eNodeB with the possibility of estimating the UE transmit power for the transmissions in which the UE transmit power is not included. When the eNodeB receives a power headroom report with a value that corresponds to a UE transmit power that is less than the maximum UE power it can use this to calculate an estimate of the downlink path loss. This estimate is then in turn used to estimate the UE transmit power until the eNodeB receives its next power headroom report.

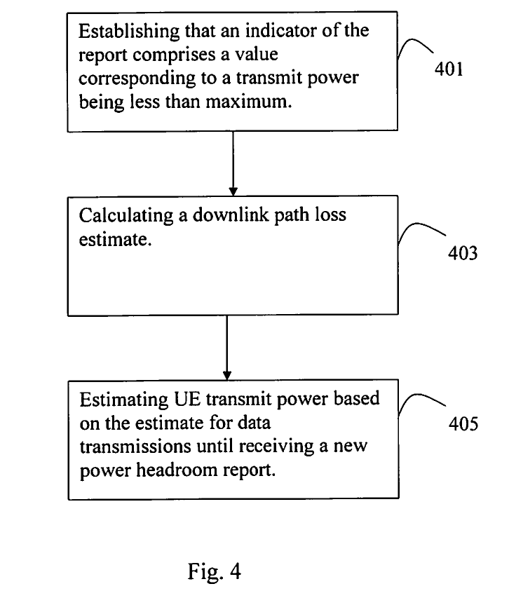

FIG. 4 in a flowchart illustrates steps performed in a base station according to one embodiment of a method for estimating UE transmit power based on a power headroom report received from the UE. The steps involve initially establishing 401 that a transmit power indicator of the received report comprises a value corresponding to a UE transmit power that is less than the maximum transmit power. Then a downlink path loss estimate is calculated 403 using this value. Thereafter the UE transmit power is estimated 405 based on that downlink path loss estimate for data transmissions until a new power headroom report is received from the UE.

In case the eNodeB has received a power headroom report with a transmit power indicator having a value corresponding to that the UE is transmitting with maximum UE power, it is instead assumed that the UE is transmitting with maximum power until it receives the next power headroom report. Triggers a) and b) are complemented with trigger c) to prevent that the eNodeB loses track of the UE transmit power due to errors in power control commands or due to HARQ Nack to Ack errors.

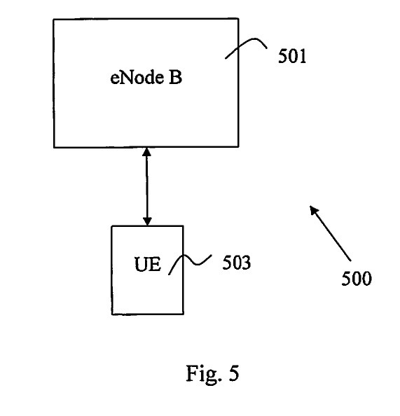

In FIG. 5, a general view of a cellular radio system 500 is depicted. The system can for example be a Long-Term Evolution (LTE) system or a similar system. The system 500 comprises a base station (eNode B) 501. The base station 501 serves a number of mobile terminals, usually termed User Equipment (UE) 503, located within the area covered by the base station 501.

Advantages with the present invention relates to enabling the eNodeB to estimate the transmit power of the UE and hence the uplink path gain without the UE having to include a power headroom report in every data transmission.

Herein described method steps of the invention may be implemented by software executed by a processor in one or several network nodes, such as a mobile terminal also called user equipment, UE, or mobile station, and/or a radio base station also called NodeB or eNodeB.

Any examples and terminology relating to 3GPP LTE standard being used herein should not be seen as limiting the scope of the invention, the methodology of which in principle can be applied to other systems as well, including e.g. WCDMA.

The described subject matter is of course not limited to the above described embodiments, but can be modified within the scope of the general concept of the invention.

1. A method in a user equipment (UE) of a wireless communication system for triggering transmitting a power headroom report to a base station, for use in estimating UE transmit power comprising the steps of;
determining if at least one preconfigured condition for triggering transmitting a power headroom report is true, and if at least one of the conditions is found true,
generating a report comprising a UE transmit power indicator, and
transmitting the report with the indicator to the base station for use therein to estimate the UE transmit power.

2. The method according to claim 1, wherein the indicator comprises a value corresponding to a difference between the UE maximum power and the UE transmit power, either absolute or per resource block.

3. The method according to claim 1, wherein the indicator comprises a value corresponding to the UE transmit power, either absolute or per resource block.

4. The method according to claim 1, wherein the triggering conditions comprise at least;
a) a certain deviation from a value of a previously reported power headroom,
b) a certain change in downlink path loss estimate used for power setting,
c) a certain elapsed time since a previously reported power headroom.

5. The method according to claim 1, wherein condition a) is true if the current UE transmit power is less than the maximum transmit power and the value of the latest transmitted report corresponds to a UE transmit power being equal to the maximum power;
condition b) is true if the downlink path loss change is larger than a certain threshold and the value of the latest transmitted report corresponds to a UE transmit power being less than the maximum power, and
condition c) is true if the time since the latest power headroom report transmission is larger than a certain threshold.

6. The method according to claim 5, wherein the threshold values of conditions b) and c) are configured in the UE via higher layer signaling, said higher layer signal being RRC signaling.

7. A method in a base station of a wireless communication system for estimating UE transmit power for transmissions based on a power headroom report received from the UE, the method comprising the steps of;
checking if a transmit power indicator of the received report comprises a value corresponding to a UE transmit power that is less than the maximum power, and in case the value indicates that the UE transmit power is less than the maximum power,
calculating a downlink path loss estimate using said value, and
estimating the UE transmit power based on said downlink path loss estimate for data transmissions until receiving a new power headroom report from the UE.

8. The method according to claim 7, wherein if the checked indicator value is found corresponding to a UE transmit power that is equal to the maximum power, it is instead assumed that the UE transmits data at maximum power until receiving a new power headroom report.

9. A user equipment (Ue) of a wireless communication system which can trigger power headroom report transmissions, wherein the UE comprises:
means for determining if at least one preconfigured condition for triggering transmitting a power headroom report is true, and if at least one of the conditions is found true,
means for generating a report comprising a UE transmit power indicator, and
means for transmitting the report with the indicator to the base station for use therein to estimate the UE transmit power.

10. The method according to claim 9, wherein the indicator comprises a value corresponding to a difference between the UE maximum power and the UE transmit power, either absolute or per resource block.

11. The UE according to claim 9, wherein the indicator comprises a value corresponding to the UE transmit power, either absolute or per resource block.

12. The UE according to claim 9, wherein the triggering conditions comprise;
a) a certain deviation from a value of a previously reported power headroom,
b) a certain change in downlink path loss estimate used for power setting, and
c) a certain elapsed time since a previously reported power headroom.

13. The UE according to claim 12, wherein
condition a) is true if the current UE transmit power is less than the maximum transmit power and the value of the latest transmitted report corresponds to a UE transmit power being equal to the maximum power;
condition b) is true if the downlink path loss change is larger than a certain threshold and the value of the latest transmitted report corresponds to a UE transmit power being less than the maximum power, and
condition c) is true if the time since the latest power headroom report transmission is larger than a certain threshold.

14. The UE according to claim 13, wherein the threshold values of conditions b) and c) are configured in the UE via higher layer signaling, wherein the higher layer signaling is RRC signaling.

15. A base station of a wireless communication system capable of estimating UE transmit power based on power headroom reports from a UE, wherein the base station comprises:
means for:
checking if a transmit power indicator of the received report comprises a value corresponding to a UE transmit power that is less than the maximum power, and in case the value indicates that the UE transmit power is less than the maximum power,
calculating a downlink path loss estimate using said value, and
estimating the UE transmit power based on said downlink path loss estimate for data transmissions until receiving a new power headroom report from the UE.

16. The base station of claim 10, wherein if the checked indicator value is found corresponding to a UE transmit power that is equal to the maximum power, the UE transmits data at maximum power until receiving a new power headroom report
